(19) United States
(12) Patent Application Publication
(10) Pub. No.: US 2006/0146375 A1
(43) Pub. Date: Jul. 6, 2006

(54) Scan unit and image forming apparatus having the same

(75) Inventor: Ki-dong Baek, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/299,826

(22) Filed: Dec. 13, 2005

(30) Foreign Application Priority Data
Jan. 5, 2005 (KR) 2005-850

(51) Int. Cl. H04N 1/04

(52) U.S. Cl. 358/474

(57) ABSTRACT

A scan unit improved in stability and reliability, and an image forming apparatus having the same. The scan unit includes a scan frame having a document tray for putting a document thereon; a reading sensor moving under the document tray and thereby reading the document; a cover selectively opening and closing the document tray; and a locking unit locking and releasing the reading sensor together with the cover.

### CROSS-REFERENCE TO RELATED APPLICATIONS

This application claims the benefit of Korean Patent Application No. 2005-850, filed Jan. 5, 2005 in the Korean Intellectual Property Office, the disclosure of which is incorporated herein by reference.

### BACKGROUND OF THE INVENTION

1. Field of the Invention

The present invention relates to an image forming apparatus. More particularly, the present invention relates to an image forming apparatus having a scan unit.

2. Description of the Related Art

Generally, image forming apparatuses capable of scanning, such as a copier, a multifunction apparatus and a facsimile, include a document tray for putting thereon a document to be scanned, a reading sensor for reading out image information from the document put on the document tray, an image formation unit for forming an image on a printing medium based on the image information read by the reading sensor, and a cover for exposing and closing the document tray.

Additionally, the image forming apparatus includes a locking member to prevent the reading sensor from being spontaneously moved and therefore broken when the image forming apparatus is moved.

However, since the locking member is not exposed to the outside, a user can check the locking state only through a display unit of an operation panel which shows operation status of the image forming apparatus. Therefore, sometimes the user may perform scanning, being unaware that the reading sensor is locked by the locking member.

In this case, since a motor for operating the reading sensor cannot move the locked reading sensor, the motor gets overloaded. In addition, a power transmission member for conveying power of the motor to the reading sensor may be mechanically damaged due to the overload. Also, a main controller which regulates the motor may be electrically damaged by the overload generated at the motor.

This repeat damage cause the motor, the power transmission member and the main controller not to work properly, thereby shortening lifespan of the scan unit or the image forming apparatus.

### SUMMARY OF THE INVENTION

An aspect of the present invention is to solve the above and/or other problems and disadvantages and to provide at least the advantages described below. Accordingly, an aspect of the present invention provides a scan unit which can be more stably operated, and an image forming apparatus having the same.

According to another aspect of the present invention there is provided a scan unit having improved lifespan, and an image forming apparatus having the same.

In order to achieve the above-described aspects of the present invention, there is provided a scan unit including a scan frame having a document tray for putting a document thereon, a reading sensor moving under the document tray and thereby reading the document, a cover selectively opening and closing the document tray, and a locking unit locking and releasing the reading sensor together with the cover.

According to another aspect of the present invention, there is provided an image forming apparatus including a scan unit reading a document, and a main frame receiving an image formation unit which forms an image by image information from the document, the scan unit including a scan frame mounted in the main frame and having a document tray for putting a document thereon, a reading sensor moving under the document tray and thereby reading the document, a cover selectively opening and closing the document tray, and a locking unit locking and releasing the reading sensor together with the cover.

According to another aspect of the present invention, he locking unit is slidably mounted in the scan frame. The locking unit includes a first locking member restricting movement of the reading sensor, a second locking member restricting opening of the cover, a base supporting the first and the second locking members, a guide member supported by the base, and a handle formed on the base and exposed to the outside of the scan unit. The scan frame includes a first guide groove guiding the first locking member, a second guide groove guiding the second locking member, and a third guide groove guiding the guide member. The second locking member has a first hook on one end and the cover has a hook hole corresponding to the first hook. One end of the guide member includes at least one second hook which slides in contact with the third guide groove. The first and the second locking members, the guide member, the handle and the base are formed as one body. The cover has an automatic document feeder (ADF).

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view schematically showing an image forming apparatus according to an embodiment of the present invention;

FIG. 2 is a sectional view of FIG. 1 cut along a line II-II;

FIG. 3 is a sectional view of FIG. 1 cut along a line III-III;

FIG. 4 is a perspective view showing the main elements of FIG. 1; and

FIGS. 5A and 5B are sectional views for explaining the operation of a locking unit according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In the following description, the defined matters, such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

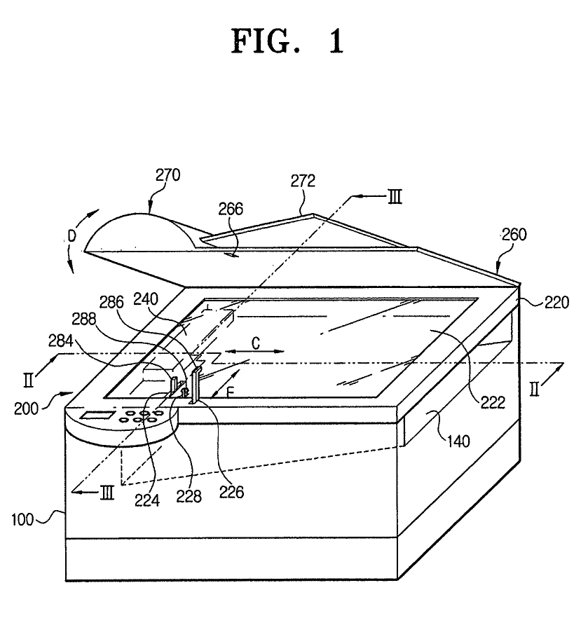

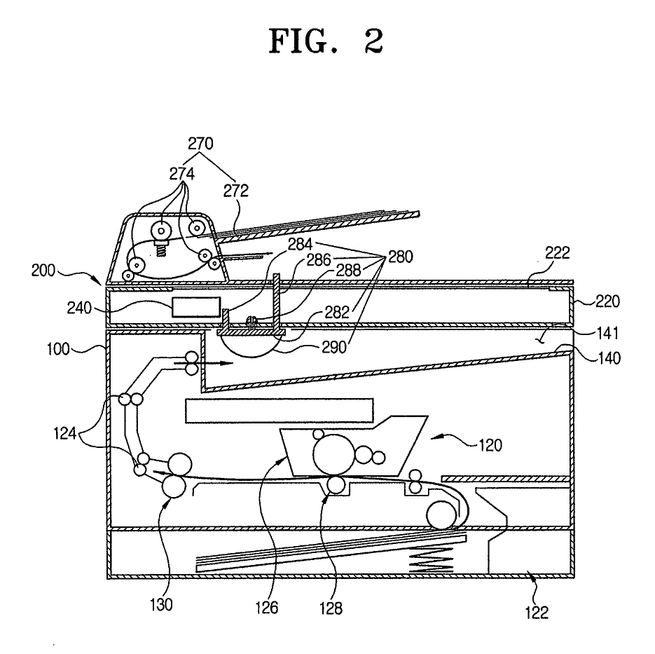

Referring to FIGS. 1 to 3, an image forming apparatus according to an embodiment of the present invention includes a main frame 100, an image formation unit 120 (FIG. 2) and a scan unit 200.

The main frame 100 supports the scan unit 200 and houses the image formation unit 120 which forms an image on a printing medium according to information read by the scan unit 200. The main frame 100 includes a discharged-paper tray 140 for receiving the printing medium as printed with the image and discharged, on a side facing the scan unit 200.

The image formation unit 120 includes a paper feeding device 122 receiving the printing medium, a plurality of feeding rollers 124 conveying the printing medium supplied from the paper feeding device 122, a developing unit 126 forming the image on the conveyed printing medium, a transfer unit 128 and a fixing unit 130. Since processes for forming the image on the printing medium are generally known, they will not be described in detail.

The scan unit 200 includes a scan frame 220, a reading sensor 240, a cover 260 and a locking unit 280.

The scan frame 220 is fixed on an upper side of the main frame 100. On an upper side of the scan frame 220, a document tray 222 is provided to put thereon a document to be scanned. The document tray 222 may be formed of platen glass for the reading sensor 240 to read the image information therethrough.

The reading sensor 240 is mounted in the scan frame 220 to reciprocate transversely, that is, in an arrowed direction C in FIG. 1 and is driven by a motor (not shown). Since the operation structure of the reading sensor 240 is well-known in the art, detailed description thereof will be omitted herein. The reading sensor 240 reads the image information of the document put on the document tray 222 by moving transversely. A charge-coupled device (CCD) is typically used for the reading sensor 240; however, a contact image sensor (CIS) may be used.

The cover 260 is mounted to the scan frame 220 pivotably in an arrowed direction D of FIG. 1 to selectively open and close the document tray 222. The cover 260 is provided with an automatic document feeder (ADF) 270 automatically supplying the document for scanning of the document.

The ADF 270 includes an ADF document tray 272 for putting thereon the document to be automatically fed, a document sensor (not shown) for detecting whether the document is stacked on the ADF document tray 272, a plurality of ADF feeding rollers 274 for conveying the document, and a registration sensor (not shown) for arranging the document being conveyed. As the document is conveyed by the plurality of feeding rollers 274 in the above-structured ADF 270, the reading sensor 240 reads the image information. In other words, in order to read the image information of the document, the document rather than the reading sensor 240 directly moves and therefore, the reading sensor 240 does not have to move.

As shown in FIG. 4, the locking unit 280 includes a base 282, first and second locking members 284 and 286 formed on one side of the base 282, a guide member 288 and a handle 290 formed on the other side of the base 282.

The base 282 is formed integrally with the first and the second locking members 284 and 286, the guide member 288 and the handle 290 by injection molding, for example, to support respectively one ends of the first and the second locking members 284 and 286 and the guide member 288. The base 282 is disposed under a lower side of the scan frame 220 and in a discharging space 141 of the discharged-paper tray 140. Although the locking unit 280 is formed as one body in this embodiment, the present invention is not limited so; therefore, the respective parts may be separately formed and connected by dedicated fastening means or bonded to the base 282.

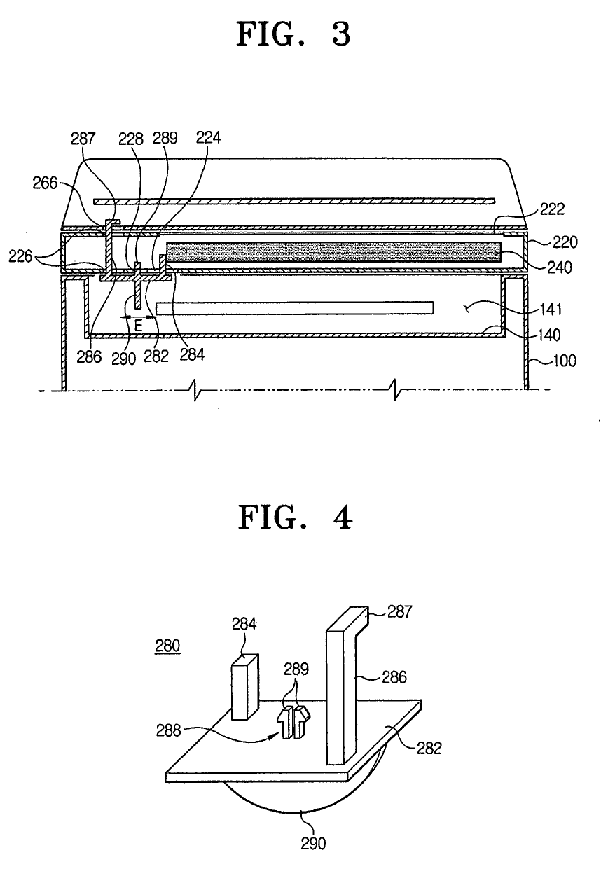

The first locking member 284 is inserted in a first guide groove 224 formed in the scan frame 220 and slides in an arrowed direction E of FIG. 3, that is, forward and backward of the image forming apparatus. By sliding against the moving direction C of the reading sensor 240, the first locking member 284 can prevent the reading sensor 240 from moving spontaneously.

The second locking member 286 is inserted in the second guide groove 226 formed in the scan frame 220 and slides in the arrowed direction E of FIG. 3, that is, to a front and a rear of the image forming apparatus. The other end of the second locking member 286 has a first hook 287, whereas the cover 260 has a hook hole 266 corresponding to the first hook 287. Therefore, when the second locking member 286 slides to the rear of the image forming apparatus, the first hook 287 is engaged with the hook hole 266 and accordingly, the cover 260 is locked and cannot be opened. When the second locking member 286 slides to the front of the image forming apparatus, the cover 260 is released to be pivotable on the scan frame 220.

The guide member 288 is inserted in a third guide groove 228 formed in the scan frame 220. On the other end of the guide member 288, a pair of second hooks 289 are formed to not only prevent escape thereof from the third guide groove 228 but also guide the movement of the locking unit 280 forward and backward. When being inserted in the third guide groove 228, the second hooks 289 are compressed and after being inserted, they return to the original position so as to be engaged with the third guide groove 228. In other words, the guide member 288 is engaged with the scan frame 220 in a hooking manner.

The handle 290 is formed on the other side of the base 282 to be exposed to the outside of the scan unit 200 so that a user can operate the locking unit 280 using the handle 290. Therefore, the handle 290 is disposed in the discharging space 141 of the discharged-paper tray 140 formed on the one side of the main frame 10.

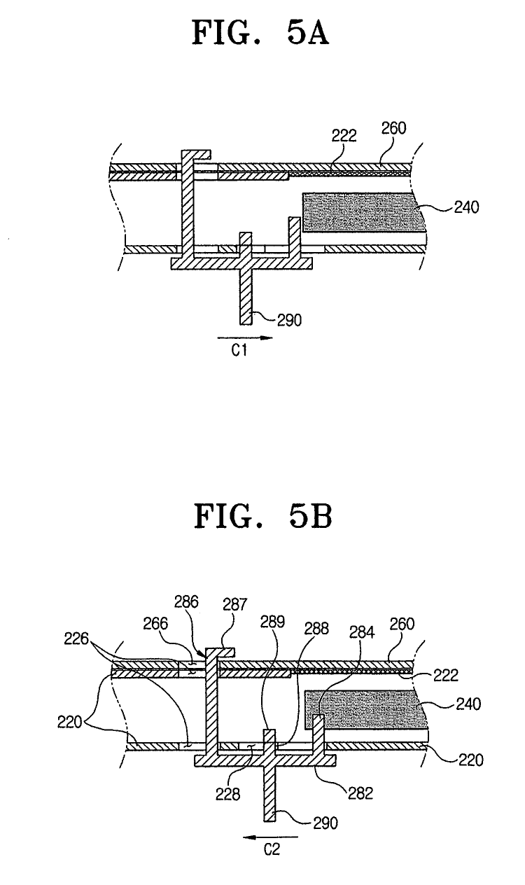

Hereinbelow, the operation of the embodiment of the present invention will be described with reference to FIGS. 5A and 5B.

Referring to FIG. 5A, the reading sensor 240 and the cover 260 are unlocked and therefore, the user can perform a scanning job by opening the cover 260 and putting the document on the document tray 222. However, in order to tilt or relocate the image forming apparatus, the user has to lock and fix the reading sensor 240 to prevent the reading sensor 240 from moving and thereby being damaged.

To specify the locking processes, first, the user moves the handle 290 disposed in the discharging space 141 (FIG. 1) in a direction C1. Then, as shown in FIG. 5B, the base 282, the first and the second locking members 284 and 286 integrally formed with the base 282 and the guide member 286 are moved in the direction C1. At this time, the second hook 289 formed at the guide member 288 guides the base 282 in the third guide groove 228 formed in the scan frame 220. The first locking member 284, as moving in the direction C1 which is perpendicular to the moving direction of the reading sensor 240, blocks the moving path of the reading sensor 240. Accordingly, the reading sensor 240 is immovably fixed to the scan frame 220. The second locking member 286 moves along the second guide groove 226 formed in the cover 260 and the scan frame 220. The first hook 287 formed on the other side of the second locking member 286 comes into engagement with the hook hole 266 and accordingly, the cover 260 is locked and not opened from the scan frame 220. In order to release the locking state, the handle 290 is moved in a direction C2 so that the cover 260 and the reading sensor 240 are unlocked as shown in FIG. 5A.

Thus, since the cover 260 can be locked at the time of locking the reading sensor 240 by the locking unit 280 (FIG. 4), the user cannot open the cover 260 to perform the scanning job with the reading sensor 240 locked. As a result, damage of the power transmission member (not shown) and the motor (not shown) transmitting the power to the reading sensor 240 can be prevented.

As can be appreciated from the above description, since damage of the power transmission member and the motor can be prevented by locking the cover and the reading sensor together, stability and reliability of the scan unit and the image forming apparatus having the scan unit are improved.

Furthermore, the lifespan of the scan unit and the image forming apparatus also can be improved.

While the invention has been shown and described with reference to certain embodiments thereof, it will be understood by those skilled in the art that various changes in form and details may be made therein without departing from the spirit and scope of the invention as defined by the appended claims.

What is claimed is:

1. A scan unit comprising:
a scan frame having a document tray for putting a document thereon;
a reading sensor moving under the document tray and thereby reading the document;
a cover selectively opening and closing the document tray; and
a locking unit locking and releasing the reading sensor together with the cover.

2. The scan unit of claim 1, wherein the locking unit is slidably mounted in the scan frame.

3. The scan unit of claim 2, wherein the locking unit comprises:
a first locking member restricting movement of the reading sensor; and
a second locking member restricting opening of the cover.

4. The scan unit of claim 3, wherein the locking unit further comprises:
a base supporting the first and the second locking members; and
a guide member supported by the base.

5. The scan unit of claim 4, wherein the locking unit further comprises a handle formed on the base and exposed to the outside of the scan unit.

6. The scan unit of claim 5, wherein the scan frame comprises:
a first guide groove guiding the first locking member;
a second guide groove guiding the second locking member; and
a third guide groove guiding the guide member.

7. The scan unit of claim 6, wherein the second locking member has a first hook on one end and the cover has a hook hole corresponding to the first hook.

8. The scan unit of claim 6, wherein one end of the guide member includes at least one second hook which slides in contact with the third guide groove.

9. The scan unit of claim 8, wherein the first and the second locking members, the guide member, the handle and the base are formed as one body.

10. The scan unit of claim 8, wherein the cover has an automatic document feeder (ADF).

11. An image forming apparatus comprising:
a scan unit reading a document; and
a main frame housing an image formation unit which forms an image by image information from the document,
the scan unit comprising, a scan frame mounted in the main frame and having a document tray to place a document thereon, a reading sensor moving under the document tray and thereby reading the document, a cover selectively opening and closing the document tray, and a locking unit locking and releasing the reading sensor together with the cover.

12. The image forming apparatus of claim 11, wherein the locking unit is slidably mounted in the scan frame.

13. The image forming apparatus of claim 12, wherein the locking unit comprises:
a first locking member restricting movement of the reading sensor; and
a second locking member restricting opening of the cover.

14. The image forming apparatus of claim 13, wherein the locking unit further comprises:
a base supporting the first and the second locking members; and
a guide member supported by the base.

15. The image forming apparatus of claim 14, wherein the main frame includes at one side a discharged-paper tray facing the scan frame, and the locking unit further comprises a handle formed on the base and exposed to the outside of the scan unit.

16. The image forming apparatus of claim 15, wherein the scan frame comprises:
a first guide groove guiding the first locking member;
a second guide groove guiding the second locking member; and
a third guide groove guiding the guide member.

17. The image forming apparatus of claim 16, wherein the second locking member has a first hook on one end and the cover has a hook hole corresponding to the first hook.

18. The image forming apparatus of claim 16, wherein one end of the guide member includes at least one second hook which slides in contact with the third guide groove.

19. The image forming apparatus of claim 18, wherein the first and the second locking members, the guide member, the handle and the base are formed as one body.

20. The image forming apparatus of claim 18, wherein the cover has an automatic document feeder (ADF).

21. An image forming apparatus comprising:
a main frame housing an image formation unit, the image formation unit forming an image on a printing medium from a document, and
a scan unit mounted on the main frame scanning the document, wherein the scan unit comprises, a scan frame having a document tray to place the document thereon, a reading sensor moving under the document tray and reading the document, a cover selectively opening and closing the document tray, and a locking unit locking and releasing the reading sensor and the cover concurrently.

22. The image forming apparatus of claim 21, wherein the reading sensor is mounted on the scan frame to reciprocate transversely.

23. The image forming apparatus of claim 21, wherein the cover includes an automatic document feeder automatically supplying the document for scanning of the document.

24. The image forming apparatus of claim 21, wherein the main frame further includes a discharged-paper tray receiving the printing medium, on a side facing the scan unit.

25. The image forming apparatus of claim 21, wherein the locking unit includes a base, first and second locking members, a guide member and a handle formed on one side of the base.

26. The image forming apparatus of claim 21, wherein the base is formed integrally with the first and the second locking members, the guide member and the handle by injection molding.

27. The image forming apparatus of claim 25, wherein the base is disposed under a lower side of the scan frame and in a discharging space of a discharged paper tray.

28. The image forming apparatus of claim 25, wherein the first locking member is inserted in a first guide groove formed in the scan frame and slides in a direction perpendicular to a sliding direction of the reading sensor.

29. The image forming apparatus of claim 25, wherein the second locking member is inserted in a second guide groove formed in the scan frame and slides in a direction perpendicular to a sliding direction of the reading sensor.

30. The image forming apparatus of claim 25, wherein the guide member is inserted in a third guide groove formed in the scan frame.

31. The image forming apparatus of claim 25, wherein the guide member includes a pair of second hooks guiding the movement of the locking unit in a first and second direction.

32. The image forming apparatus of claim 25, wherein the handle if formed on a side of the base and exposed to an outside of the scan unit allowing a user to operate the locking unit using the handle.

33. The image forming apparatus of claim 32, wherein the handle is disposed in a discharging space of the discharged-paper tray formed on one side of the main frame.

34. An image forming apparatus comprising:
a main frame housing an image formation unit, the image formation unit forming an image on a printing medium from a document, and
a scan unit mounted on the main frame scanning the document, wherein the scan unit comprises, a scan frame having a document tray to place the document thereon, a reading sensor moving under the document tray and reading the document, a cover selectively opening and closing the document tray, and a locking unit, wherein the locking unit locks the reading sensor when the cover is locked and releases the reading sensor when the cover is unlocked.
